(19) United States
(12) Patent Application Publication
(10) Pub. No.: US 2026/0143422 A1
(43) Pub. Date: May 21, 2026

(54) FREQUENCY MODULATED CONTINUOUS WAVE-BASED SYNCHRONIZATION SIGNAL BLOCK AND LOW POWER SYNCHRONIZATION SIGNAL

(71) Applicant: QUALCOMM Incorporated, San Diego, CA (US)

(72) Inventors: Weimin DUAN, San Diego, CA (US); Kangqi LIU, San Diego, CA (US); Jing SUN, San Diego, CA (US); Huilin XU, Temecula, CA (US); Jing LEI, San Diego, CA (US)

(21) Appl. No.: 18/955,466

(22) Filed: Nov. 21, 2024

(51) Int. Cl. H04W 52/02; H04L 27/02; H04L 27/10; H04W 48/08

(52) U.S. Cl. CPC H04W 52/0203; H04L 27/02; H04L 27/10; H04W 48/08

(57) ABSTRACT

Methods, systems, and devices for wireless communications are described. A network entity may generate an on-off keying (OOK) waveform associated with communication of low power synchronization signal (LP-SS) signaling. The OOK waveform may include one or more on durations and one or more off durations. The network entity may generate a frequency modulated continuous wave (FMCW) waveform associated with communication of synchronization signal block (SSB) signaling. The network entity may transmit a modulated waveform comprising the FMCW waveform modulated with the OOK waveform on the plurality of on durations of the OOK waveform.

### FIELD OF TECHNOLOGY

The following relates to wireless communications, including frequency modulated continuous wave-based synchronization signal block and low power synchronization signal.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some scenarios, a wireless device may communicate synchronization signaling. However, such approaches may be improved.

### SUMMARY

The systems, methods, and devices of this disclosure each have several innovative aspects, no single one of which is solely responsible for the desirable attributes disclosed herein.

A method for wireless communications by a network entity is described. The method may include generating an on-off keying (OOK) waveform associated with communication of low power synchronization signal (LP-SS) signaling, the OOK waveform including a set of multiple on durations and a set of multiple off durations, generating a frequency modulated continuous wave (FMCW) waveform associated with communication of synchronization signal block (SSB) signaling, and transmitting a modulated waveform including the FMCW waveform modulated with the OOK waveform on the set of multiple on durations of the OOK waveform.

A network entity for wireless communications is described. The network entity may include one or more memories storing processor executable code, and one or more processors coupled with the one or more memories. The one or more processors may individually or collectively be operable to execute the code to cause the network entity to generate an on-off keying (OOK) waveform associated with communication of low power synchronization signal (LP-SS) signaling, the OOK waveform including a set of multiple on durations and a set of multiple off durations, generate a frequency modulated continuous wave (FMCW) waveform associated with communication of synchronization signal block (SSB) signaling, and transmit a modulated waveform including the FMCW waveform modulated with the OOK waveform on the set of multiple on durations of the OOK waveform.

Another network entity for wireless communications is described. The network entity may include means for generating an on-off keying (OOK) waveform associated with communication of low power synchronization signal (LP-SS) signaling, the OOK waveform including a set of multiple on durations and a set of multiple off durations, means for generating a frequency modulated continuous wave (FMCW) waveform associated with communication of synchronization signal block (SSB) signaling, and means for transmitting a modulated waveform including the FMCW waveform modulated with the OOK waveform on the set of multiple on durations of the OOK waveform.

A non-transitory computer-readable medium storing code for wireless communications is described. The code may include instructions executable by one or more processors to generate an on-off keying (OOK) waveform associated with communication of low power synchronization signal (LP-SS) signaling, the OOK waveform including a set of multiple on durations and a set of multiple off durations, generate a frequency modulated continuous wave (FMCW) waveform associated with communication of synchronization signal block (SSB) signaling, and transmit a modulated waveform including the FMCW waveform modulated with the OOK waveform on the set of multiple on durations of the OOK waveform.

Some examples of the method, network entities, and non-transitory computer-readable medium described herein may further include operations, features, means, or instructions for transmitting multiple durations of the OOK waveform within a time period associated with a single orthogonal frequency domain multiplexing (OFDM) symbol duration.

Some examples of the method, network entities, and non-transitory computer-readable medium described herein may further include operations, features, means, or instructions for transmitting the modulated waveform in accordance with a primary synchronization signaling (PSS) only occasion.

Some examples of the method, network entities, and non-transitory computer-readable medium described herein may further include operations, features, means, or instructions for transmitting, via the LP-SS signaling, an indication of a timing offset between the LP-SS signaling and the SSB signaling, a frequency offset between the LP-SS signaling and the SSB signaling, or both.

Some examples of the method, network entities, and non-transitory computer-readable medium described herein may further include operations, features, means, or instructions for transmitting the LP-SS signaling based on an association between the LP-SS signaling and a cell identifier of a cell that may be associated with the network entity.

Some examples of the method, network entities, and non-transitory computer-readable medium described herein may further include operations, features, means, or instructions for transmitting an indication that the LP-SS signaling may be associated with the cell identifier of the cell.

In some examples of the method, network entities, and non-transitory computer-readable medium described herein, generating the FMCW waveform may include operations, features, means, or instructions for generating at least a portion of the FMCW waveform to include a slope that may be associated with an identifier of a cell that may be associated with the network entity.

In some examples of the method, network entities, and non-transitory computer-readable medium described herein, generating the OOK waveform may include operations, features, means, or instructions for generating the OOK waveform in accordance with a slope modulation-based waveform shape, where the LP-SS signaling includes slope modulation based signaling.

In some examples of the method, network entities, and non-transitory computer-readable medium described herein, generating the FMCW waveform may include operations, features, means, or instructions for generating the FMCW waveform in accordance with an X FMCW waveform shape, a V FMCW waveform shape, or a single slope FMCW waveform shape.

A method for wireless communications by a user equipment (UE) is described. The method may include monitoring for low power synchronization signal (LP-SS) signaling associated with an on-off keying (OOK) waveform that includes a set of multiple on durations and a set of multiple off durations and monitoring, during at least a portion of the set of multiple on durations of the OOK waveform, for SSB signaling associated with a frequency modulated continuous wave (FMCW) waveform overlaid in the set of multiple on durations of the OOK waveform.

A UE for wireless communications is described. The UE may include one or more memories storing processor executable code, and one or more processors coupled with the one or more memories. The one or more processors may individually or collectively be operable to execute the code to cause the UE to monitor for low power synchronization signal (LP-SS) signaling associated with an on-off keying (OOK) waveform that includes a set of multiple on durations and a set of multiple off durations and monitor, during at least a portion of the set of multiple on durations of the OOK waveform, for SSB signaling associated with a frequency modulated continuous wave (FMCW) waveform overlaid in the set of multiple on durations of the OOK waveform.

Another UE for wireless communications is described. The UE may include means for monitoring for low power synchronization signal (LP-SS) signaling associated with an on-off keying (OOK) waveform that includes a set of multiple on durations and a set of multiple off durations and means for monitoring, during at least a portion of the set of multiple on durations of the OOK waveform, for SSB signaling associated with a frequency modulated continuous wave (FMCW) waveform overlaid in the set of multiple on durations of the OOK waveform.

A non-transitory computer-readable medium storing code for wireless communications is described. The code may include instructions executable by one or more processors to monitor for low power synchronization signal (LP-SS) signaling associated with an on-off keying (OOK) waveform that includes a set of multiple on durations and a set of multiple off durations and monitor, during at least a portion of the set of multiple on durations of the OOK waveform, for SSB signaling associated with a frequency modulated continuous wave (FMCW) waveform overlaid in the set of multiple on durations of the OOK waveform.

Some examples of the method, user equipment (UEs), and non-transitory computer-readable medium described herein may further include operations, features, means, or instructions for receiving a modulated waveform including the FMCW waveform modulated on the set of multiple on durations of the OOK waveform with the OOK waveform.

Some examples of the method, user equipment (UEs), and non-transitory computer-readable medium described herein may further include operations, features, means, or instructions for receiving multiple durations of the OOK waveform within a time period associated with a single orthogonal frequency domain multiplexing (OFDM) symbol duration.

Some examples of the method, user equipment (UEs), and non-transitory computer-readable medium described herein may further include operations, features, means, or instructions for receiving the SSB signaling in association with a primary synchronization signaling (PSS) only occasion.

Some examples of the method, user equipment (UEs), and non-transitory computer-readable medium described herein may further include operations, features, means, or instructions for receiving, via the LP-SS signaling, an indication of a timing offset between the LP-SS signaling and the SSB signaling, a frequency offset between the LP-SS signaling and the SSB signaling, or both.

Some examples of the method, user equipment (UEs), and non-transitory computer-readable medium described herein may further include operations, features, means, or instructions for determining a cell identifier of a cell based on reception of the LP-SS signaling and an association between the LP-SS signaling and the cell identifier.

Some examples of the method, user equipment (UEs), and non-transitory computer-readable medium described herein may further include operations, features, means, or instructions for receiving an indication that the LP-SS signaling may be associated with the identifier of the cell.

Some examples of the method, user equipment (UEs), and non-transitory computer-readable medium described herein may further include operations, features, means, or instructions for receiving a modulated waveform including the FMCW waveform modulated on the set of multiple on durations of the OOK waveform with the OOK waveform, where at least a portion of the FMCW waveform includes a slope that may be associated with an identifier of a cell that may be associated with a network entity that transmitted the SSB signaling.

In some examples of the method, user equipment (UEs), and non-transitory computer-readable medium described herein, the OOK waveform may be based on a slope modulation-based waveform shape, and the LP-SS signaling includes slope modulation based signaling.

In some examples of the method, user equipment (UEs), and non-transitory computer-readable medium described herein, the FMCW waveform includes an X FMCW waveform shape, a V FMCW waveform shape, or a single slope FMCW waveform shape.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports frequency modulated continuous wave-based synchronization signal block and low power synchronization signal in accordance with one or more examples as disclosed herein.

FIG. 2 shows an example of a wireless communications system that supports frequency modulated continuous wave-based synchronization signal block and low power synchronization signal in accordance with one or more examples as disclosed herein.

FIG. 3 shows an example of a process flow that supports frequency modulated continuous wave-based synchronization signal block and low power synchronization signal in accordance with one or more examples as disclosed herein.

FIGS. 4 and 5 show block diagrams of devices that support frequency modulated continuous wave-based synchronization signal block and low power synchronization signal in accordance with one or more examples as disclosed herein.

FIG. 6 shows a block diagram of a communications manager that supports frequency modulated continuous wave-based synchronization signal block and low power synchronization signal in accordance with one or more examples as disclosed herein.

FIG. 7 shows a diagram of a system including a device that supports frequency modulated continuous wave-based synchronization signal block and low power synchronization signal in accordance with one or more examples as disclosed herein.

FIGS. 8 and 9 show block diagrams of devices that support frequency modulated continuous wave-based synchronization signal block and low power synchronization signal in accordance with one or more examples as disclosed herein.

FIG. 10 shows a block diagram of a communications manager that supports frequency modulated continuous wave-based synchronization signal block and low power synchronization signal in accordance with one or more examples as disclosed herein.

FIG. 11 shows a diagram of a system including a device that supports frequency modulated continuous wave-based synchronization signal block and low power synchronization signal in accordance with one or more examples as disclosed herein.

FIGS. 12 and 13 show flowcharts illustrating methods that support frequency modulated continuous wave-based synchronization signal block and low power synchronization signal in accordance with one or more examples as disclosed herein.

### DETAILED DESCRIPTION

In wireless communications, a low power synchronization signal (LP-SS) may be employed for synchronization and radio resource management (RRM) measurement operations. Further, in some scenarios, a synchronization signal block (SSB) may also be transmitted to aid in synchronization and cell searching. However, in some scenarios, transmitting both a primary synchronization signal (PSS) and a secondary synchronization signal (SSS) in association with an SSB as well as transmitting an LP-SS may cause increase resource overhead and increased network energy consumption, as both signals may serve the purpose of synchronization and radio resource management (RRM) measurement.

In some examples, a “light” SSB signal may be transmitted via a frequency modulated continuous wave (FMCW) waveform that is modulated onto “on” durations of an on-off keying (OOK) waveform used to transmit the LP-SS signaling, allowing for overlaying of the FMCW-based light SSB signaling on the OOK-based LP-SS signaling. By doing so, resource overhead and network energy consumption may be decreased, as separate transmission of LP-SS and SSB signaling may not be performed. Further, other separate signaling (e.g., independently-transmitted FMCW based light SSB signaling) may be replaced or supplemented by the overlaid signaling described herein, increasing capabilities while reducing resource overhead and network energy consumption.

Aspects of the disclosure are initially described in the context of wireless communications systems. Aspects of the disclosure are then described herein with reference to a wireless communications system and a process flow. Aspects of the disclosure are further illustrated by and described herein with reference to apparatus diagrams, system diagrams, and flowcharts that relate to frequency modulated continuous wave-based synchronization signal block and low power synchronization signal.

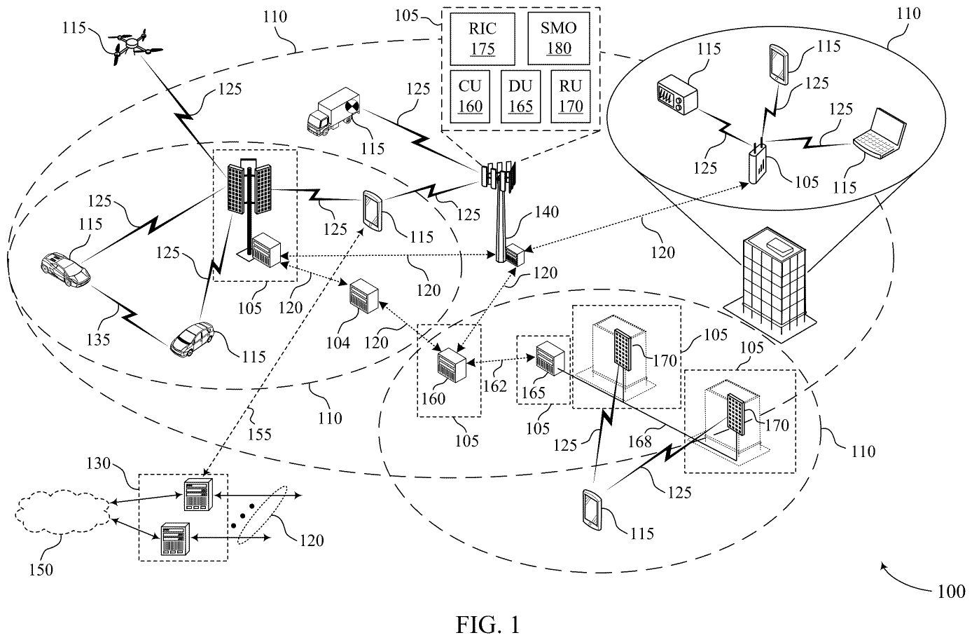

FIG. 1 shows an example of a wireless communications system 100 that supports frequency modulated continuous wave-based synchronization signal block and low power synchronization signal in accordance with one or more examples as disclosed herein. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support frequency modulated continuous wave-based synchronization signal block and low power synchronization signal as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described herein with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a network entity 105 may transmit (e.g., to a UE 115) a OOK waveform, where a FMCW waveform may be overlaid (e.g., modulated or overlaid in another way) with the OOK waveform during the on portions of the OOK waveform. For example, the FMCW waveform may provide information that is to be encoded or included in the on durations of the OOK waveform. In some examples, the OOK waveform may be used to transmit LP-SS signaling (or other synchronization signaling) and the FMCW waveform may be used to transmit SSB signaling (or other signaling). Such overlaid signaling may be employed for one or more use cases, including cell discovery and synchronization, radio resource management (RRM) or other cell specific measurement operations (e.g., tracking loops), delivery of broadcast or other control information using slope modulation techniques, one or more other scenarios or use cases, or any combination thereof.

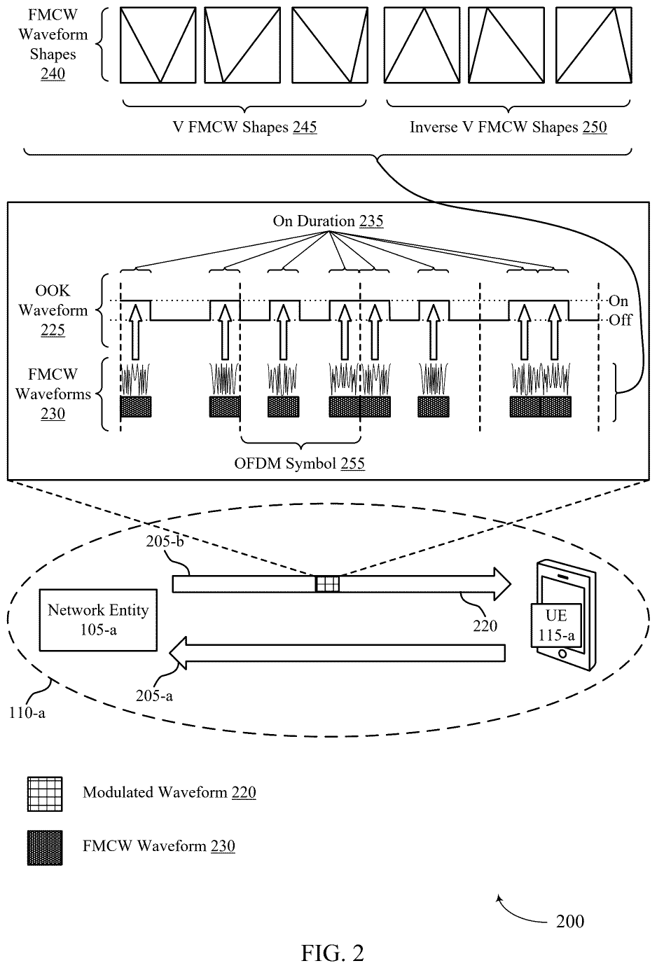

FIG. 2 shows an example of a wireless communications system 200 that supports frequency modulated continuous wave-based synchronization signal block and low power synchronization signal in accordance with one or more examples as disclosed herein.

The wireless communications system 200 may include the network entity 105-a, which may be an example of one or more network entities discussed in relation to other figures. The wireless communications system 200 may include the UE 115-a, which may be an example of UEs discussed in relation to other figures.

In some examples, the UE 115-a may be located in a geographic coverage area 110-a that may be associated with the network entity 105-a. The network entity 105-a and UE 115-a may communicate via one or more downlink communication links 205-a and one or more uplink communication links 205-b.

In some wireless communication scenarios, overlaid sequences for low power wake up signals (LP-WUSs) may be employed. Such techniques may include the use of overlaid sequences in On symbol durations of OOK signals. For example, in an OOK On symbol, either random phase signals or a preconfigured sequence may be overlaid. For the former, the overlaid sequence may flatten the LP-WUS spectrum for better detection performance in frequency selective channels. For the latter, the overlaid sequence can additionally carry the LP-WUS information.

In some examples, the overlaid sequence may include similar properties to OFDM signals, such as full bandwidth transmission in the allocated LP-WUS bandwidth, higher sampling rate with respect to the OOK symbol rate, or a (relatively) flat spectrum. In some examples, the overlaid sequence may be generated by OFDM modulation with IFFT. In some examples, the overlaid sequence may not change the non-coherent envelope detection of OOK modulated LP-WUS. Further, in some examples, IQ receiver-based LP-WUR techniques may be employed to detect the overlaid sequence in time domain without the use of a fast Fourier transform (FFT) or in frequency domain with the use of an FFT. In some examples, the IQ receiver may have a lower noise figure (NF) or a higher processing gain (e.g., due to coherent detection) than the OOK based receiver. In some examples, an information data rate of overlaid sequences may be higher than the OOK signals in scenarios in which the two achieve similar coverage.

In some examples, a LP-SS may be used for synchronization and RRM measurement. In some examples, for nearby cells, different LP-SSs may be transmitted so that the LP-WUR does not synchronize to a neighbor cell's downlink timing or may not affect RRM measurement. In some examples, a quantity (e.g., a maximum quantity) of binary sequences may be configured for LP-SS, such as 3 sequences, 4 sequences (e.g., based on four color theorem), 8 or 16 (e.g., if an LP-SS can be detected in non-nearest neighbors), or any other quantity of binary sequences. In some examples, the binary LP-SS sequence may be down-selected from a Gold sequence, an M sequence, a computer searched sequence, one or more other sequences, or any combination thereof. In some examples, similar to the LP-WUS, an overlaid sequence may be transmitted during the on duration of LP-SS (e.g., during an on duration of an OOK waveform). In some examples, the overlaid sequence may be also cell specific.

In some examples, a “simple” signal (e.g., a “light” SSB) can be used by a network entity to announce the deployment of the network entity or a cell, simplifying the UE initial cell search. In some examples, after a UE detects the light SSB, the UE may determine that the cell is deployed and may stay on the sync raster for a longer time period to search for the actual SSB (e.g., a full or normal SSB). In some examples, a FMCW based cell detection signal can be used as the “simple” signal (e.g., light SSB). In some examples, the UE may scan multiple sync raster points at a time, with relatively low complexity. In some examples, FMCW spreading may help distinguish light SSB from data during scanning operations (e.g., which may be more robust than energy-based detection). In some examples, a full search performance of FMCW-based PSS may match PSS using M-sequence techniques with a correlation-based detector. In some examples, an FMCW signal may include a natural time or frequency ambiguity. In such cases, a FMCW shape such as an X FMCW shape may be used to remove the ambiguity.

In some examples, the use of such “overlaid sequences” in association with an LP-SS may provide increased flexibility for UE implementation of a low power wake up receiver (LP-WUR) to achieve a trade-off between power consumption and measurement reliability. For example, the IQ based LP-WUR may include or be associated with a lower NF and higher processing gain (e.g., due to coherent detection than the OOK based receiver). In some examples, the IQ based LP-WUR may receive the overlaid OFDM sequences of LP-SS for synchronization and RRM measurement. In some examples, the IQ based LP-WUR may process PSS signaling, SSS signaling, or both in association with an SSB.

In some examples, transmitting one or more of a PSS and an SSS from an SSB and LP-SS may result in additional resource overhead and extra network energy consumption, as both serve the purpose of synchronization and RRM measurement. Given the benefits of FMCW based light SSB, it may be desirable to consider the joint transmission of FMCW based light SSB and low power OOK signals.

In some examples, an “overlaid FMCW” for LP-SS may be employed. For example, the overlaid FMCW waveform 230 may be transmitted in On durations 235 of an OOK waveform 225 associated with transmission of the LP-SS.

In some examples, the overlaid FMCW waveform 230 may also be transmitted in the OOK On durations 235 of the LP-WUS. However, since the LP-WUS may not always be transmitted, the network entity 105-a may not regularly transmit the overlaid FMCW waveform 230. In other words, because both LP-SS and FMCW waveform-based light SSB are broadcast signals, it may be desirable to bundle these two in the same transmission. In some examples, such techniques may augment or replace the FMCW waveform-based light SSB transmissions or as a supplementary light SSB transmission scheme (e.g., for non-cell defining (NCD) light SSB in bandwidth where cell defining (CD) light SSB may not be available). In some examples, the functionality of NCD-light SSB may be useful for reduced capability (RedCap) UEs, which may benefit more from LP-WUR power saving. In some examples, designation of signaling as “light” (e.g., a light SSB) may indicate that synchronization signals of the SSB may be transmitted and one or more other signals may not be transmitted.

In some examples, synchronization information associated with the OOK LP-SS still uses the waveform envelope to carry the synchronization information. Within each OOK On duration 235, one or more FMCW waveforms 230 may be transmitted (e.g., optionally depending on the OOK symbol duration). For example, in some such techniques, M=4 On or Off symbols may be transmitted in each OFDM symbol 255 duration.

The OFDM symbol 255 duration may be used as the basic time unit to promote time alignment between the LP-WUS and other signaling that may be multiplexed (e.g., via frequency domain multiplexing (FDM) techniques) with the LP-WUS. However, in some examples, the techniques may be general enough if the OFDM symbol 255 duration is just defined as a reference time unit.

In some examples, the UE 115-a may utilize LP-WUR signaling to search for or locate OOK LP-SS signaling for synchronization information. Additionally, or alternatively, the UE 115-a may utilize measurement and reporting (MR) to search FMCW for synchronization information.

For example, in some cases, the network entity 105-a may generate the OOK waveform 225 that may be used to carry the LP-SS signaling, and the network entity 105-a may further generate one or more FMCW waveforms 230 that may be used to carry the SSB signaling (e.g., light SSB signaling). The network entity 105-a may overlay or modulate the FMCW waveforms 230 during one or more on durations 235 of the OOK waveform 225 to produce the modulated waveform 220, which may be transmitted to the UE 115-a to communicate both the signaling associated with the OOK waveform 225 (e.g., the LP-SS signaling) and the signaling associated with the FMCW waveforms 230 (e.g., the light SSB signaling). In some examples, the FMCW waveforms 230 may provide the information that is to be carried during the one or more on durations 235 of the OOK waveform 225.

In some examples, overlay techniques (including the techniques described herein) may be employed to support cell discovery or cell synchronization operations. For example, the FMCW waveforms 230 overlaid on the OOK waveform 225 may be used to transmit a light SSB or a PSS-only occasion (or other subset of a full SSB), which may be used for cell discovery, time offset estimation, frequency offset estimation, one or more other discovery or synchronization operations, or any combination thereof. In some examples, to perform initial access operations, a full SSB may be transmitted (e.g., after initial discovery or synchronization is performed in accordance with the light SSB or a PSS-only occasion.

In some examples, a timing offset, a frequency offset, or both, between LP-SS signaling (e.g., transmitted via the OOK waveform 225) and SSB signaling (e.g., transmitted via the FMCW waveforms 230) may be implicitly indicated by OOK LP-SS signaling or as part of the LP-SS. Such information may aid the UE 115-a to access the cell after cell discovery. In some examples, the OOK LP-SS signaling may be associated with the timing offset, the frequency offset, or both between the LP-SS signaling and the SSB signaling. In some examples, after the UE 115-a discovers the FMCW waveforms 230 successfully, the UE 115-a may decode the LP-SS signaling to determine the timing offset, the frequency offset, or both between the LP-SS signaling and the SSB signaling.

In some examples, overlay techniques (including the techniques described herein) may be employed to support RRM operations, cell specific measurement operations (e.g., tracking loop operations), one or more other operations, or any combination thereof. For example, for nearby cells, different modulated waveforms 220 (e.g., each including one or more FMCW waveforms 230 modulated or overlaid on the OOK waveform 225) may be transmitted (e.g., by the network entity 105-a) so that the LP-WUR does not synchronize to a neighbor cell's downlink timing or so that RRM measurement is not impacted.

In some examples, the network entity 105-a may implicitly indicate the cell identifier (ID) with the OOK LP-SS signaling. In some examples, the OOK LP-SS may be associated with the cell ID, and after the UE 115-a receives the FMCW successfully, the UE 115-a may further decode the LP-SS signaling to differentiate between different cells. In some examples, the association of the OOK LP-SS signaling and the cell ID may be predefined and made available to the network entity 105-a and the UE 115-a. For example, for the LP-WUR (e.g., in association with a power saving mode), the UE 115-a may have connected to the network before (e.g., via the network entity 105-a). If so, the network entity 105-a may indicate the LP-SS sequence to the UE 115-a. Additionally, or alternatively, for the MR operations (e.g., an initial cell search phase), after detecting the FMCW, the UE 115-a may further decode the LP-SS sequence to determine the cell ID (e.g., in line with the predefined association between the OOK LP-SS signaling and the cell ID).

In some examples, the cell ID may be implicitly indicated jointly by the OOK LP-SS signaling and the FMCW waveform shapes 240. For example, the slopes of the FMCW waveform shapes 240 and the OOK LP-SS may be jointly used to indicate the cell ID. For example, in a V shape FMCW, multiple V shape FMCW candidates may be employed to communicate multiple cell ID associations or cell IDs. The FMCW waveform shapes 240 may include, as examples, one or more V FMCW shapes 245, one or more inverse V FMCW shapes 250, or any combination thereof. The slopes may include symmetrical shapes or asymmetrical shapes (e.g., which may “lean” forwards in time or backwards in time, as shown).

In some examples, overlay techniques (including the techniques described herein) may be employed to support delivery of broadcast or other control information (e.g., via slope modulations). For example, the LP-SS signaling may be generated as slope modulation-based signaling (to facilitate low complexity reception). In some examples, the complexity for slope-based signaling may be lower than sequence-based signaling.

In some examples, the FMCW waveforms 230 may be of any suitable shape or slope, including X shape FMCW waveforms, V shape FMCW waveforms, single slope FMCW waveforms (e.g., rising or falling), or any combination thereof.

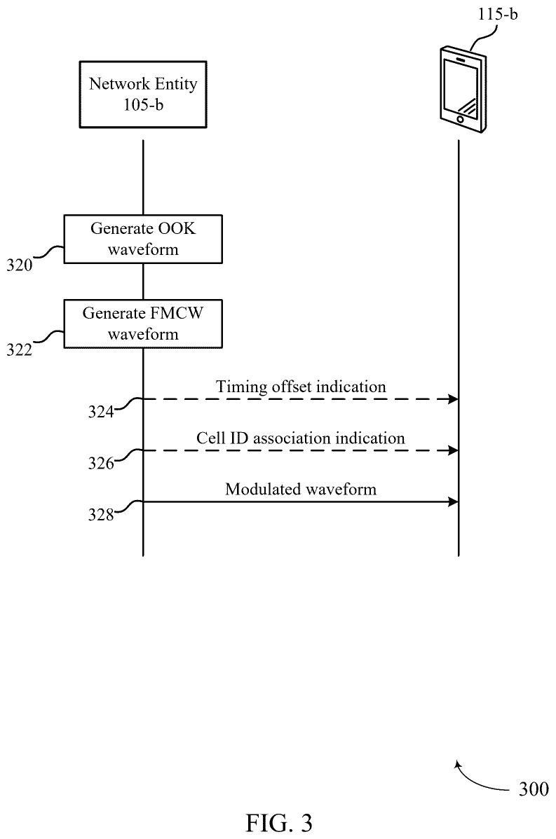

FIG. 3 shows an example of a process flow 300 that supports frequency modulated continuous wave-based synchronization signal block and low power synchronization signal in accordance with one or more examples as disclosed herein. The process flow 300 may implement various aspects of the present disclosure described herein. The elements described in the process flow 300 (e.g., the network entity 105-b and the UE 115-b) may be examples of similarly named elements described herein.

In the following description of the process flow 300, the operations between the various entities or elements may be performed in different orders or at different times. Some operations may also be left out of the process flow 300, or other operations may be added. Although the various entities or elements are shown performing the operations of the process flow 300, some aspects of some operations may also be performed by other entities or elements of the process flow 300 or by entities or elements that are not depicted in the process flow, or any combination thereof.

At 320, the network entity 105-b may generate an on-off keying (OOK) waveform associated with communication of low power synchronization signal (LP-SS) signaling, the OOK waveform that may include a plurality of on durations and a plurality of off durations. In some examples, the network entity 105-b may generate the OOK waveform in accordance with a slope modulation-based waveform shape and the LP-SS signaling may include slope modulation based signaling.

At 322, the network entity 105-b may generate a frequency modulated continuous wave (FMCW) waveform associated with communication of synchronization signal block (SSB) signaling. In some examples, the network entity 105-b may generate at least a portion of the FMCW waveform to include a slope that is associated with an identifier of a cell that is associated with the network entity. Additionally, or alternatively, the network entity 105-b may generate the FMCW waveform in accordance with an X FMCW waveform shape, a V FMCW waveform shape, or a single slope FMCW waveform shape.

At 324, the network entity 105-b may transmit, via the LP-SS signaling, an indication of a timing offset between the LP-SS signaling and the SSB signaling, a frequency offset between the LP-SS signaling and the SSB signaling, or both.

At 326, the network entity 105-b may transmit an indication that the LP-SS signaling is associated with the cell identifier of the cell.

At 328, the network entity 105-b may transmit a modulated waveform that may include the FMCW waveform modulated with the OOK waveform on the plurality of on durations of the OOK waveform. In some examples, the network entity 105-b may transmit multiple durations of the OOK waveform within a time period associated with a single orthogonal frequency domain multiplexing (OFDM) symbol duration. In some examples, the network entity 105-b may transmit the modulated waveform in accordance with a primary synchronization signaling (PSS)-only occasion. In some examples, the network entity 105-b may transmit the LP-SS signaling based on an association between the LP-SS signaling and a cell identifier of a cell that is associated with the network entity.

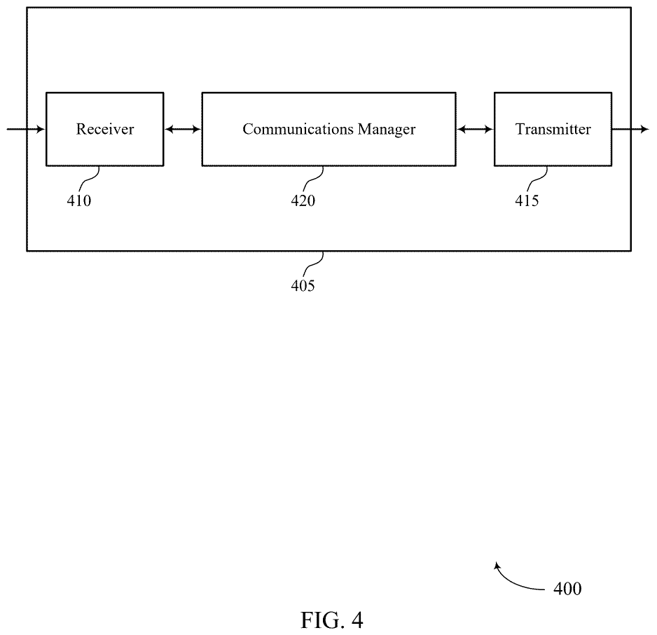

FIG. 4 shows a block diagram 400 of a device 405 that supports frequency modulated continuous wave-based synchronization signal block and low power synchronization signal in accordance with one or more examples as disclosed herein. The device 405 may be an example of aspects of a network entity 105 as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 405. In some examples, the receiver 410 may support obtaining information by receiving signals via one or more antennas. Additionally, or alternatively, the receiver 410 may support obtaining information by receiving signals via one or more wired (e.g., electrical, fiber optic) interfaces, wireless interfaces, or any combination thereof.

The transmitter 415 may provide a means for outputting (e.g., transmitting, providing, conveying, sending) information generated by other components of the device 405. For example, the transmitter 415 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 415 may support outputting information by transmitting signals via one or more antennas. Additionally, or alternatively, the transmitter 415 may support outputting information by transmitting signals via one or more wired (e.g., electrical, fiber optic) interfaces, wireless interfaces, or any combination thereof. In some examples, the transmitter 415 and the receiver 410 may be co-located in a transceiver, which may include or be coupled with a modem.

The communications manager 420, the receiver 410, the transmitter 415, or various combinations or components thereof may be examples of means for performing various aspects of frequency modulated continuous wave-based synchronization signal block and low power synchronization signal as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

Additionally, or alternatively, the communications manager 420 may support wireless communications in accordance with examples as disclosed herein. For example, the communications manager 420 is capable of, configured to, or operable to support a means for generating an on-off keying (OOK) waveform associated with communication of low power synchronization signal (LP-SS) signaling, the OOK waveform including a set of multiple on durations and a set of multiple off durations. The communications manager 420 is capable of, configured to, or operable to support a means for generating a frequency modulated continuous wave (FMCW) waveform associated with communication of synchronization signal block (SSB) signaling. The communications manager 420 is capable of, configured to, or operable to support a means for transmitting a modulated waveform including the FMCW waveform modulated with the OOK waveform on the set of multiple on durations of the OOK waveform.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, more efficient utilization of communication resources, or any combination thereof.

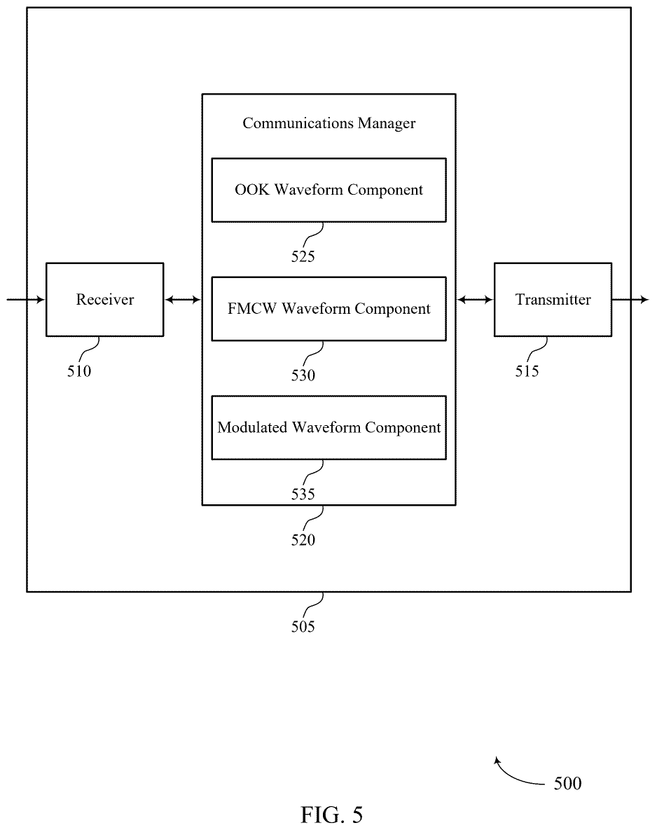

FIG. 5 shows a block diagram 500 of a device 505 that supports frequency modulated continuous wave-based synchronization signal block and low power synchronization signal in accordance with one or more examples as disclosed herein. The device 505 may be an example of aspects of a device 405 or a network entity 105 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 505. In some examples, the receiver 510 may support obtaining information by receiving signals via one or more antennas. Additionally, or alternatively, the receiver 510 may support obtaining information by receiving signals via one or more wired (e.g., electrical, fiber optic) interfaces, wireless interfaces, or any combination thereof.

The transmitter 515 may provide a means for outputting (e.g., transmitting, providing, conveying, sending) information generated by other components of the device 505. For example, the transmitter 515 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 515 may support outputting information by transmitting signals via one or more antennas. Additionally, or alternatively, the transmitter 515 may support outputting information by transmitting signals via one or more wired (e.g., electrical, fiber optic) interfaces, wireless interfaces, or any combination thereof. In some examples, the transmitter 515 and the receiver 510 may be co-located in a transceiver, which may include or be coupled with a modem.

The device 505, or various components thereof, may be an example of means for performing various aspects of frequency modulated continuous wave-based synchronization signal block and low power synchronization signal as described herein. For example, the communications manager 520 may include a OOK waveform component 525, an FMCW waveform component 530, a modulated waveform component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications in accordance with examples as disclosed herein. The OOK waveform component 525 is capable of, configured to, or operable to support a means for generating an on-off keying (OOK) waveform associated with communication of low power synchronization signal (LP-SS) signaling, the OOK waveform including a set of multiple on durations and a set of multiple off durations. The FMCW waveform component 530 is capable of, configured to, or operable to support a means for generating a frequency modulated continuous wave (FMCW) waveform associated with communication of synchronization signal block (SSB) signaling. The modulated waveform component 535 is capable of, configured to, or operable to support a means for transmitting a modulated waveform including the FMCW waveform modulated with the OOK waveform on the set of multiple on durations of the OOK waveform.

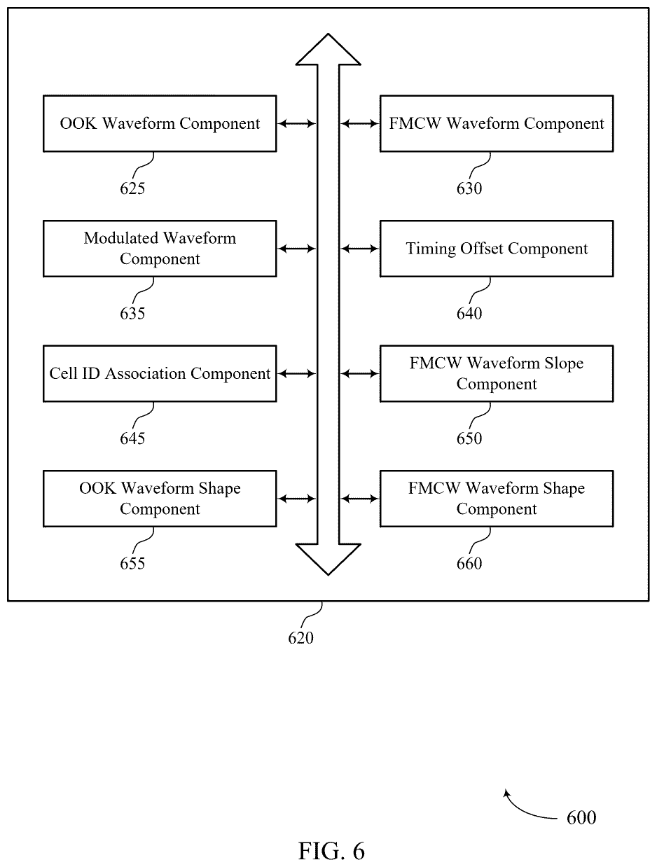

FIG. 6 shows a block diagram 600 of a communications manager 620 that supports frequency modulated continuous wave-based synchronization signal block and low power synchronization signal in accordance with one or more examples as disclosed herein. The communications manager 620 may be an example of aspects of a communications manager 420, a communications manager 520, or both, as described herein. The communications manager 620, or various components thereof, may be an example of means for performing various aspects of frequency modulated continuous wave-based synchronization signal block and low power synchronization signal as described herein. For example, the communications manager 620 may include a OOK waveform component 625, an FMCW waveform component 630, a modulated waveform component 635, a timing offset component 640, a cell ID association component 645, an FMCW waveform slope component 650, a OOK waveform shape component 655, an FMCW waveform shape component 660, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 620 may support wireless communications in accordance with examples as disclosed herein. The OOK waveform component 625 is capable of, configured to, or operable to support a means for generating an on-off keying (OOK) waveform associated with communication of low power synchronization signal (LP-SS) signaling, the OOK waveform including a set of multiple on durations and a set of multiple off durations. The FMCW waveform component 630 is capable of, configured to, or operable to support a means for generating a frequency modulated continuous wave (FMCW) waveform associated with communication of synchronization signal block (SSB) signaling. The modulated waveform component 635 is capable of, configured to, or operable to support a means for transmitting a modulated waveform including the FMCW waveform modulated with the OOK waveform on the set of multiple on durations of the OOK waveform.

In some examples, the OOK waveform component 625 is capable of, configured to, or operable to support a means for transmitting multiple durations of the OOK waveform within a time period associated with a single orthogonal frequency domain multiplexing (OFDM) symbol duration.

In some examples, the modulated waveform component 635 is capable of, configured to, or operable to support a means for transmitting the modulated waveform in accordance with a primary synchronization signaling (PSS) only occasion.

In some examples, the timing offset component 640 is capable of, configured to, or operable to support a means for transmitting, via the LP-SS signaling, an indication of a timing offset between the LP-SS signaling and the SSB signaling, a frequency offset between the LP-SS signaling and the SSB signaling, or both.

In some examples, the cell ID association component 645 is capable of, configured to, or operable to support a means for transmitting the LP-SS signaling based on an association between the LP-SS signaling and a cell identifier of a cell that is associated with the network entity.

In some examples, the cell ID association component 645 is capable of, configured to, or operable to support a means for transmitting an indication that the LP-SS signaling is associated with the cell identifier of the cell.

In some examples, to support generating the FMCW waveform, the FMCW waveform slope component 650 is capable of, configured to, or operable to support a means for generating at least a portion of the FMCW waveform to include a slope that is associated with an identifier of a cell that is associated with the network entity.

In some examples, to support generating the OOK waveform, the OOK waveform shape component 655 is capable of, configured to, or operable to support a means for generating the OOK waveform in accordance with a slope modulation-based waveform shape, where the LP-SS signaling includes slope modulation based signaling.

In some examples, to support generating the FMCW waveform, the FMCW waveform shape component 660 is capable of, configured to, or operable to support a means for generating the FMCW waveform in accordance with an X FMCW waveform shape, a V FMCW waveform shape, or a single slope FMCW waveform shape.

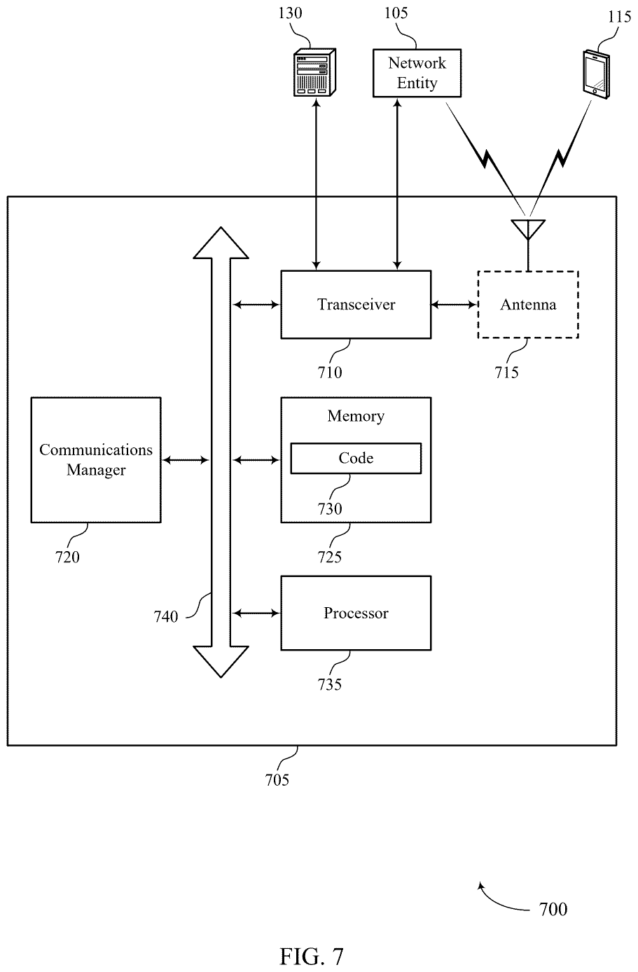

FIG. 7 shows a diagram of a system 700 including a device 705 that supports frequency modulated continuous wave-based synchronization signal block and low power synchronization signal in accordance with one or more examples as disclosed herein. The device 705 may be an example of or include components of a device 405, a device 505, or a network entity 105 as described herein. The device 705 may communicate with other network devices or network equipment such as one or more of the network entities 105, UEs 115, or any combination thereof. The communications may include communications over one or more wired interfaces, over one or more wireless interfaces, or any combination thereof. The device 705 may include components that support outputting and obtaining communications, such as a communications manager 720, a transceiver 710, one or more antennas 715, at least one memory 725, code 730, and at least one processor 735. These components may be in electronic communication or otherwise coupled (e.g., operatively, communicatively, functionally, electronically, electrically) via one or more buses (e.g., a bus 740).

The transceiver 710 may support bi-directional communications via wired links, wireless links, or both as described herein. In some examples, the transceiver 710 may include a wired transceiver and may communicate bi-directionally with another wired transceiver. Additionally, or alternatively, in some examples, the transceiver 710 may include a wireless transceiver and may communicate bi-directionally with another wireless transceiver. In some examples, the device 705 may include one or more antennas 715, which may be capable of transmitting or receiving wireless transmissions (e.g., concurrently). The transceiver 710 may also include a modem to modulate signals, to provide the modulated signals for transmission (e.g., by one or more antennas 715, by a wired transmitter), to receive modulated signals (e.g., from one or more antennas 715, from a wired receiver), and to demodulate signals. In some implementations, the transceiver 710 may include one or more interfaces, such as one or more interfaces coupled with the one or more antennas 715 that are configured to support various receiving or obtaining operations, or one or more interfaces coupled with the one or more antennas 715 that are configured to support various transmitting or outputting operations, or a combination thereof. In some implementations, the transceiver 710 may include or be configured for coupling with one or more processors or one or more memory components that are operable to perform or support operations based on received or obtained information or signals, or to generate information or other signals for transmission or other outputting, or any combination thereof. In some implementations, the transceiver 710, or the transceiver 710 and the one or more antennas 715, or the transceiver 710 and the one or more antennas 715 and one or more processors or one or more memory components (e.g., the at least one processor 735, the at least one memory 725, or both), may be included in a chip or chip assembly that is installed in the device 705. In some examples, the transceiver 710 may be operable to support communications via one or more communications links (e.g., communication link(s) 125, backhaul communication link(s) 120, a midhaul communication link 162, a fronthaul communication link 168).

The at least one memory 725 may include RAM, ROM, or any combination thereof. The at least one memory 725 may store computer-readable, computer-executable, or processor-executable code, such as the code 730. The code 730 may include instructions that, when executed by one or more of the at least one processor 735, cause the device 705 to perform various functions described herein. The code 730 may be stored in a non-transitory computer-readable medium such as system memory or another type of memory. In some cases, the code 730 may not be directly executable by a processor of the at least one processor 735 but may cause a computer (e.g., when compiled and executed) to perform functions described herein. In some cases, the at least one memory 725 may include, among other things, a BIOS which may control basic hardware or software operation such as the interaction with peripheral components or devices. In some examples, the at least one processor 735 may include multiple processors and the at least one memory 725 may include multiple memories. One or more of the multiple processors may be coupled with one or more of the multiple memories which may, individually or collectively, be configured to perform various functions herein (for example, as part of a processing system).

The at least one processor 735 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 735 may be configured to operate a memory array using a memory controller. In some other cases, a memory controller may be integrated into one or more of the at least one processor 735. The at least one processor 735 may be configured to execute computer-readable instructions stored in a memory (e.g., one or more of the at least one memory 725) to cause the device 705 to perform various functions (e.g., functions or tasks supporting frequency modulated continuous wave-based synchronization signal block and low power synchronization signal). For example, the device 705 or a component of the device 705 may include at least one processor 735 and at least one memory 725 coupled with one or more of the at least one processor 735, the at least one processor 735 and the at least one memory 725 configured to perform various functions described herein. The at least one processor 735 may be an example of a cloud-computing platform (e.g., one or more physical nodes and supporting software such as operating systems, virtual machines, or container instances) that may host the functions (e.g., by executing code 730) to perform the functions of the device 705. The at least one processor 735 may be any one or more suitable processors capable of executing scripts or instructions of one or more software programs stored in the device 705 (such as within one or more of the at least one memory 725).

In some examples, the at least one processor 735 may include multiple processors and the at least one memory 725 may include multiple memories. One or more of the multiple processors may be coupled with one or more of the multiple memories, which may, individually or collectively, be configured to perform various functions herein. In some examples, the at least one processor 735 may be a component of a processing system, which may refer to a system (such as a series) of machines, circuitry (including, for example, one or both of processor circuitry (which may include the at least one processor 735) and memory circuitry (which may include the at least one memory 725)), or components, that receives or obtains inputs and processes the inputs to produce, generate, or obtain a set of outputs. The processing system may be configured to perform one or more of the functions described herein. For example, the at least one processor 735 or a processing system including the at least one processor 735 may be configured to, configurable to, or operable to cause the device 705 to perform one or more of the functions described herein. Further, as described herein, being “configured to,” being “configurable to,” and being “operable to” may be used interchangeably and may be associated with a capability, when executing code stored in the at least one memory 725 or otherwise, to perform one or more of the functions described herein.

In some examples, a bus 740 may support communications of (e.g., within) a protocol layer of a protocol stack. In some examples, a bus 740 may support communications associated with a logical channel of a protocol stack (e.g., between protocol layers of a protocol stack), which may include communications performed within a component of the device 705, or between different components of the device 705 that may be co-located or located in different locations (e.g., where the device 705 may refer to a system in which one or more of the communications manager 720, the transceiver 710, the at least one memory 725, the code 730, and the at least one processor 735 may be located in one of the different components or divided between different components).

In some examples, the communications manager 720 may manage aspects of communications with a core network 130 (e.g., via one or more wired or wireless backhaul links). For example, the communications manager 720 may manage the transfer of data communications for client devices, such as one or more UEs 115. In some examples, the communications manager 720 may manage communications with one or more other network entities 105, and may include a controller or scheduler for controlling communications with UEs 115 (e.g., in cooperation with the one or more other network devices). In some examples, the communications manager 720 may support an X2 interface within an LTE/LTE-A wireless communications network technology to provide communication between network entities 105.

Additionally, or alternatively, the communications manager 720 may support wireless communications in accordance with examples as disclosed herein. For example, the communications manager 720 is capable of, configured to, or operable to support a means for generating an on-off keying (OOK) waveform associated with communication of low power synchronization signal (LP-SS) signaling, the OOK waveform including a set of multiple on durations and a set of multiple off durations. The communications manager 720 is capable of, configured to, or operable to support a means for generating a frequency modulated continuous wave (FMCW) waveform associated with communication of synchronization signal block (SSB) signaling. The communications manager 720 is capable of, configured to, or operable to support a means for transmitting a modulated waveform including the FMCW waveform modulated with the OOK waveform on the set of multiple on durations of the OOK waveform.

By including or configuring the communications manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 720 may be configured to perform various operations (e.g., receiving, obtaining, monitoring, outputting, transmitting) using or otherwise in cooperation with the transceiver 710, the one or more antennas 715 (e.g., where applicable), or any combination thereof. Although the communications manager 720 is illustrated as a separate component, in some examples, one or more functions described herein with reference to the communications manager 720 may be supported by or performed by the transceiver 710, one or more of the at least one processor 735, one or more of the at least one memory 725, the code 730, or any combination thereof (for example, by a processing system including at least a portion of the at least one processor 735, the at least one memory 725, the code 730, or any combination thereof). For example, the code 730 may include instructions executable by one or more of the at least one processor 735 to cause the device 705 to perform various aspects of frequency modulated continuous wave-based synchronization signal block and low power synchronization signal as described herein, or the at least one processor 735 and the at least one memory 725 may be otherwise configured to, individually or collectively, perform or support such operations.

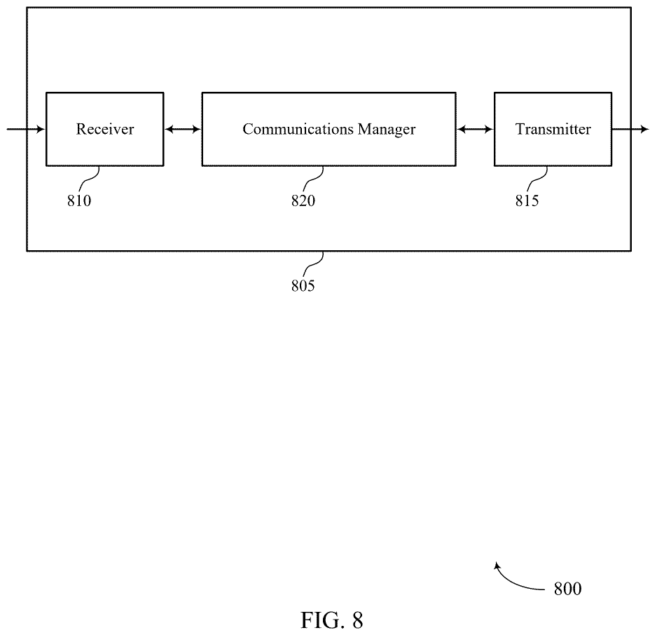

FIG. 8 shows a block diagram 800 of a device 805 that supports frequency modulated continuous wave-based synchronization signal block and low power synchronization signal in accordance with one or more examples as disclosed herein. The device 805 may be an example of aspects of a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to frequency modulated continuous wave-based synchronization signal block and low power synchronization signal). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to frequency modulated continuous wave-based synchronization signal block and low power synchronization signal). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations or components thereof may be examples of means for performing various aspects of frequency modulated continuous wave-based synchronization signal block and low power synchronization signal as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

Additionally, or alternatively, the communications manager 820 may support wireless communications in accordance with examples as disclosed herein. For example, the communications manager 820 is capable of, configured to, or operable to support a means for monitoring for low power synchronization signal (LP-SS) signaling associated with an on-off keying (OOK) waveform that includes a set of multiple on durations and a set of multiple off durations. The communications manager 820 is capable of, configured to, or operable to support a means for monitoring, during at least a portion of the set of multiple on durations of the OOK waveform, for SSB signaling associated with a frequency modulated continuous wave (FMCW) waveform overlaid in the set of multiple on durations of the OOK waveform.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for reduced processing, reduced power consumption, more efficient utilization of communication resources, or any combination thereof.

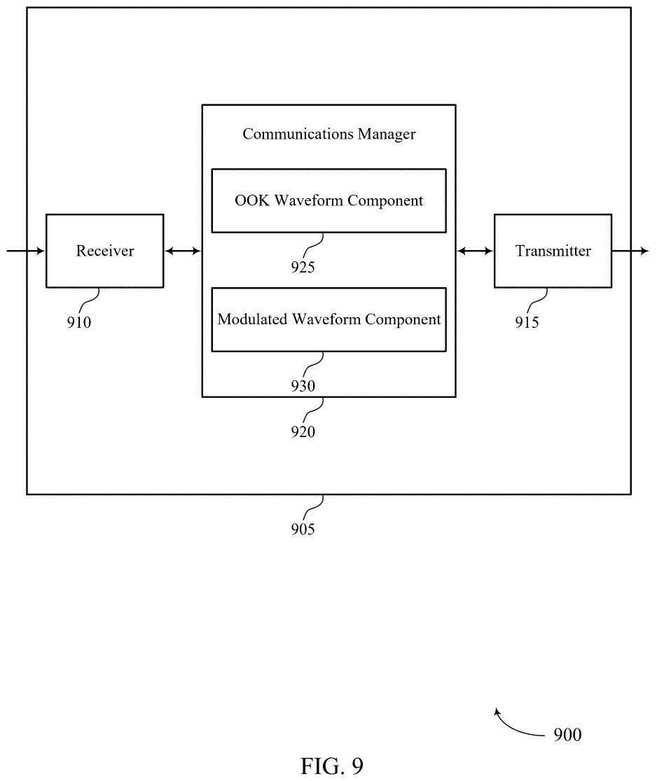

FIG. 9 shows a block diagram 900 of a device 905 that supports frequency modulated continuous wave-based synchronization signal block and low power synchronization signal in accordance with one or more examples as disclosed herein. The device 905 may be an example of aspects of a device 805 or a UE 115 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for receiving information such as packets, user data, control information, or any combination thereof associated with various information channels (e.g., control channels, data channels, information channels related to frequency modulated continuous wave-based synchronization signal block and low power synchronization signal). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to frequency modulated continuous wave-based synchronization signal block and low power synchronization signal). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of frequency modulated continuous wave-based synchronization signal block and low power synchronization signal as described herein. For example, the communications manager 920 may include a OOK waveform component 925 a modulated waveform component 930, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The OOK waveform component 925 is capable of, configured to, or operable to support a means for monitoring for low power synchronization signal (LP-SS) signaling associated with an on-off keying (OOK) waveform that includes a set of multiple on durations and a set of multiple off durations. The modulated waveform component 930 is capable of, configured to, or operable to support a means for monitoring, during at least a portion of the set of multiple on durations of the OOK waveform, for SSB signaling associated with a frequency modulated continuous wave (FMCW) waveform overlaid in the set of multiple on durations of the OOK waveform.

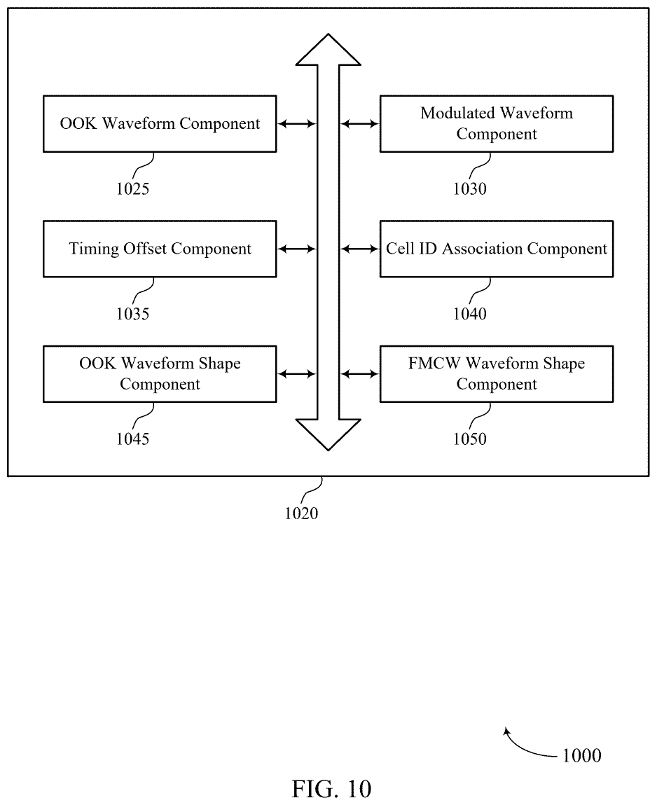

FIG. 10 shows a block diagram 1000 of a communications manager 1020 that supports frequency modulated continuous wave-based synchronization signal block and low power synchronization signal in accordance with one or more examples as disclosed herein. The communications manager 1020 may be an example of aspects of a communications manager 820, a communications manager 920, or both, as described herein. The communications manager 1020, or various components thereof, may be an example of means for performing various aspects of frequency modulated continuous wave-based synchronization signal block and low power synchronization signal as described herein. For example, the communications manager 1020 may include a OOK waveform component 1025, a modulated waveform component 1030, a timing offset component 1035, a cell ID association component 1040, a OOK waveform shape component 1045, an FMCW waveform shape component 1050, or any combination thereof. Each of these components, or components or subcomponents thereof (e.g., one or more processors, one or more memories), may communicate, directly or indirectly, with one another (e.g., via one or more buses).

Additionally, or alternatively, the communications manager 1020 may support wireless communications in accordance with examples as disclosed herein. The OOK waveform component 1025 is capable of, configured to, or operable to support a means for monitoring for low power synchronization signal (LP-SS) signaling associated with an on-off keying (OOK) waveform that includes a set of multiple on durations and a set of multiple off durations. The modulated waveform component 1030 is capable of, configured to, or operable to support a means for monitoring, during at least a portion of the set of multiple on durations of the OOK waveform, for SSB signaling associated with a frequency modulated continuous wave (FMCW) waveform overlaid in the set of multiple on durations of the OOK waveform.

In some examples, the modulated waveform component 1030 is capable of, configured to, or operable to support a means for receiving a modulated waveform including the FMCW waveform modulated on the set of multiple on durations of the OOK waveform with the OOK waveform.

In some examples, the OOK waveform component 1025 is capable of, configured to, or operable to support a means for receiving multiple durations of the OOK waveform within a time period associated with a single orthogonal frequency domain multiplexing (OFDM) symbol duration.

In some examples, the modulated waveform component 1030 is capable of, configured to, or operable to support a means for receiving the SSB signaling in association with a primary synchronization signaling (PSS) only occasion.

In some examples, the timing offset component 1035 is capable of, configured to, or operable to support a means for receiving, via the LP-SS signaling, an indication of a timing offset between the LP-SS signaling and the SSB signaling, a frequency offset between the LP-SS signaling and the SSB signaling, or both.

In some examples, the cell ID association component 1040 is capable of, configured to, or operable to support a means for determining a cell identifier of a cell based on reception of the LP-SS signaling and an association between the LP-SS signaling and the cell identifier.

In some examples, the cell ID association component 1040 is capable of, configured to, or operable to support a means for receiving an indication that the LP-SS signaling is associated with the identifier of the cell.

In some examples, the modulated waveform component 1030 is capable of, configured to, or operable to support a means for receiving a modulated waveform including the FMCW waveform modulated on the set of multiple on durations of the OOK waveform with the OOK waveform, where at least a portion of the FMCW waveform includes a slope that is associated with an identifier of a cell that is associated with a network entity that transmitted the SSB signaling.

In some examples, the OOK waveform is based on a slope modulation-based waveform shape, and the LP-SS signaling includes slope modulation based signaling.

In some examples, the FMCW waveform includes an X FMCW waveform shape, a V FMCW waveform shape, or a single slope FMCW waveform shape.

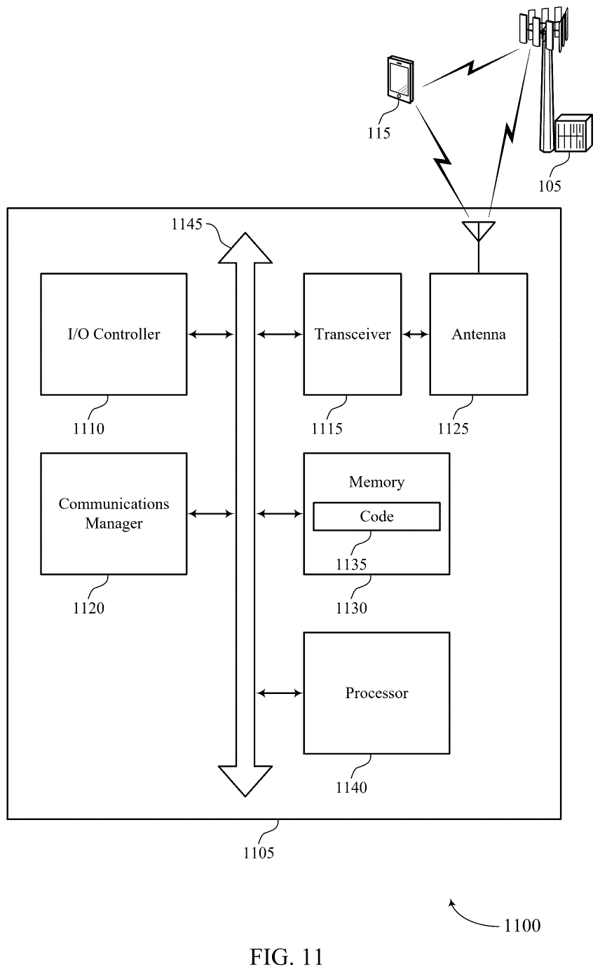

FIG. 11 shows a diagram of a system 1100 including a device 1105 that supports frequency modulated continuous wave-based synchronization signal block and low power synchronization signal in accordance with one or more examples as disclosed herein. The device 1105 may be an example of or include components of a device 805, a device 905, or a UE 115 as described herein. The device 1105 may communicate (e.g., wirelessly) with one or more other devices (e.g., network entities 105, UEs 115, or a combination thereof). The device 1105 may include components for bi-directional voice and data communications including components for transmitting and receiving communications, such as a communications manager 1120, an input/output (I/O) controller, such as an I/O controller 1110, a transceiver 1115, one or more antennas 1125, at least one memory 1130, code 1135, and at least one processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of one or more processors, such as the at least one processor 1140. In some cases, a user may interact with the device 1105 via the I/O controller 1110 or via hardware components controlled by the I/O controller 1110.

In some cases, the device 1105 may include a single antenna. However, in some other cases, the device 1105 may have more than one antenna, which may be capable of concurrently transmitting or receiving multiple wireless transmissions. The transceiver 1115 may communicate bi-directionally via the one or more antennas 1125 using wired or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The at least one memory 1130 may include random access memory (RAM) and read-only memory (ROM). The at least one memory 1130 may store computer-readable, computer-executable, or processor-executable code, such as the code 1135. The code 1135 may include instructions that, when executed by the at least one processor 1140, cause the device 1105 to perform various functions described herein. The code 1135 may be stored in a non-transitory computer-readable medium such as system memory or another type of memory. In some cases, the code 1135 may not be directly executable by the at least one processor 1140 but may cause a computer (e.g., when compiled and executed) to perform functions described herein. In some cases, the at least one memory 1130 may include, among other things, a basic I/O system (BIOS) which may control basic hardware or software operation such as the interaction with peripheral components or devices.

The at least one processor 1140 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1140 may be configured to operate a memory array using a memory controller. In some other cases, a memory controller may be integrated into the at least one processor 1140. The at least one processor 1140 may be configured to execute computer-readable instructions stored in a memory (e.g., the at least one memory 1130) to cause the device 1105 to perform various functions (e.g., functions or tasks supporting frequency modulated continuous wave-based synchronization signal block and low power synchronization signal). For example, the device 1105 or a component of the device 1105 may include at least one processor 1140 and at least one memory 1130 coupled with or to the at least one processor 1140, the at least one processor 1140 and the at least one memory 1130 configured to perform various functions described herein.

In some examples, the at least one processor 1140 may include multiple processors and the at least one memory 1130 may include multiple memories. One or more of the multiple processors may be coupled with one or more of the multiple memories, which may, individually or collectively, be configured to perform various functions described herein. In some examples, the at least one processor 1140 may be a component of a processing system, which may refer to a system (such as a series) of machines, circuitry (including, for example, one or both of processor circuitry (which may include the at least one processor 1140) and memory circuitry (which may include the at least one memory 1130)), or components, that receives or obtains inputs and processes the inputs to produce, generate, or obtain a set of outputs. The processing system may be configured to perform one or more of the functions described herein. For example, the at least one processor 1140 or a processing system including the at least one processor 1140 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code 1135 (e.g., processor-executable code) stored in the at least one memory 1130 or otherwise, to perform one or more of the functions described herein.

Additionally, or alternatively, the communications manager 1120 may support wireless communications in accordance with examples as disclosed herein. For example, the communications manager 1120 is capable of, configured to, or operable to support a means for monitoring for low power synchronization signal (LP-SS) signaling associated with an on-off keying (OOK) waveform that includes a set of multiple on durations and a set of multiple off durations. The communications manager 1120 is capable of, configured to, or operable to support a means for monitoring, during at least a portion of the set of multiple on durations of the OOK waveform, for SSB signaling associated with a frequency modulated continuous wave (FMCW) waveform overlaid in the set of multiple on durations of the OOK waveform.

By including or configuring the communications manager 1120 in accordance with examples as described herein, the device 1105 may support techniques for improved communication reliability, reduced latency, improved user experience related to reduced processing, reduced power consumption, more efficient utilization of communication resources, improved coordination between devices, longer battery life, improved utilization of processing capability, or any combination thereof.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described herein with reference to the communications manager 1120 may be supported by or performed by the at least one processor 1140, the at least one memory 1130, the code 1135, or any combination thereof. For example, the code 1135 may include instructions executable by the at least one processor 1140 to cause the device 1105 to perform various aspects of frequency modulated continuous wave-based synchronization signal block and low power synchronization signal as described herein, or the at least one processor 1140 and the at least one memory 1130 may be otherwise configured to, individually or collectively, perform or support such operations.

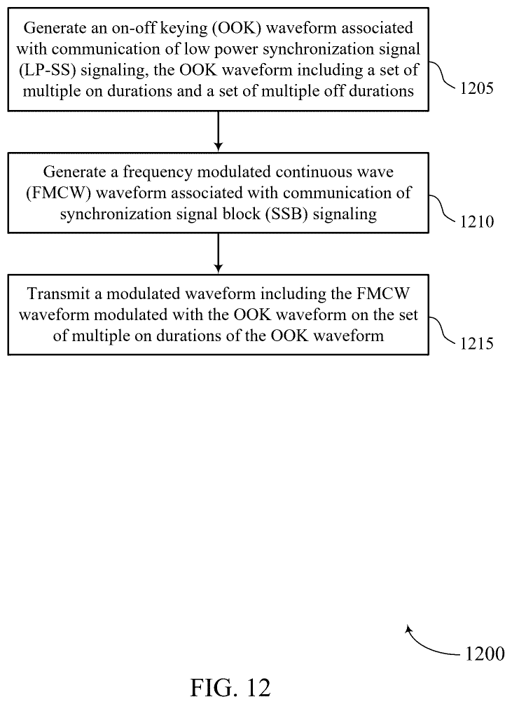

FIG. 12 shows a flowchart illustrating a method 1200 that supports frequency modulated continuous wave-based synchronization signal block and low power synchronization signal in accordance with one or more examples as disclosed herein. The operations of the method 1200 may be implemented by a network entity or its components as described herein. For example, the operations of the method 1200 may be performed by a network entity as described herein with reference to FIGS. 1 through 7. In some examples, a network entity may execute a set of instructions to control the functional elements of the network entity to perform the described functions. Additionally, or alternatively, the network entity may perform aspects of the described functions using special-purpose hardware.

At 1205, the method may include generating an on-off keying (OOK) waveform associated with communication of low power synchronization signal (LP-SS) signaling, the OOK waveform including a set of multiple on durations and a set of multiple off durations. The operations of 1205 may be performed in accordance with examples as disclosed herein. In some examples, aspects of the operations of 1205 may be performed by a OOK waveform component 625 as described herein with reference to FIG. 6.

At 1210, the method may include generating a frequency modulated continuous wave (FMCW) waveform associated with communication of synchronization signal block (SSB) signaling. The operations of 1210 may be performed in accordance with examples as disclosed herein. In some examples, aspects of the operations of 1210 may be performed by an FMCW waveform component 630 as described herein with reference to FIG. 6.

At 1215, the method may include transmitting a modulated waveform including the FMCW waveform modulated with the OOK waveform on the set of multiple on durations of the OOK waveform. The operations of 1215 may be performed in accordance with examples as disclosed herein. In some examples, aspects of the operations of 1215 may be performed by a modulated waveform component 635 as described herein with reference to FIG. 6.

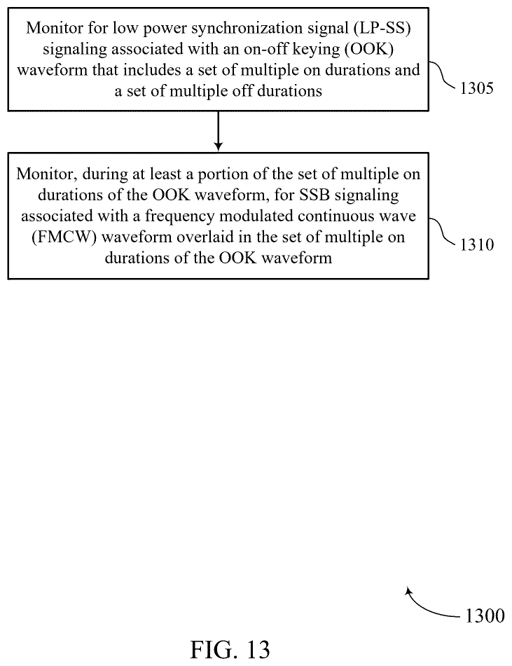

FIG. 13 shows a flowchart illustrating a method 1300 that supports frequency modulated continuous wave-based synchronization signal block and low power synchronization signal in accordance with one or more examples as disclosed herein. The operations of the method 1300 may be implemented by a UE or its components as described herein. For example, the operations of the method 1300 may be performed by a UE 115 as described herein with reference to FIGS. 1 through 3 and 8 through 11. In some examples, a UE may execute a set of instructions to control the functional elements of the UE to perform the described functions. Additionally, or alternatively, the UE may perform aspects of the described functions using special-purpose hardware.

At 1305, the method may include monitoring for low power synchronization signal (LP-SS) signaling associated with an on-off keying (OOK) waveform that includes a set of multiple on durations and a set of multiple off durations. The operations of 1305 may be performed in accordance with examples as disclosed herein. In some examples, aspects of the operations of 1305 may be performed by a OOK waveform component 1025 as described herein with reference to FIG. 10.

At 1310, the method may include monitoring, during at least a portion of the set of multiple on durations of the OOK waveform, for SSB signaling associated with a frequency modulated continuous wave (FMCW) waveform overlaid in the set of multiple on durations of the OOK waveform. The operations of 1310 may be performed in accordance with examples as disclosed herein. In some examples, aspects of the operations of 1310 may be performed by a modulated waveform component 1030 as described herein with reference to FIG. 10.

The following provides an overview of aspects of the present disclosure:

Aspect 1: A method for wireless communications at a network entity, comprising: generating an on-off keying (OOK) waveform associated with communication of low power synchronization signal (LP-SS) signaling, the OOK waveform comprising a plurality of on durations and a plurality of off durations; generating a frequency modulated continuous wave (FMCW) waveform associated with communication of synchronization signal block (SSB) signaling; and transmitting a modulated waveform comprising the FMCW waveform modulated with the OOK waveform on the plurality of on durations of the OOK waveform.

Aspect 2: The method of aspect 1, further comprising: transmitting multiple durations of the OOK waveform within a time period associated with a single orthogonal frequency domain multiplexing (OFDM) symbol duration.

Aspect 3: The method of any of aspects 1 through 2, further comprising: transmitting the modulated waveform in accordance with a primary synchronization signaling (PSS) only occasion.

Aspect 4: The method of any of aspects 1 through 3, further comprising: transmitting, via the LP-SS signaling, an indication of a timing offset between the LP-SS signaling and the SSB signaling, a frequency offset between the LP-SS signaling and the SSB signaling, or both.

Aspect 5: The method of any of aspects 1 through 4, further comprising: transmitting the LP-SS signaling based at least in part on an association between the LP-SS signaling and a cell identifier of a cell that is associated with the network entity.

Aspect 6: The method of aspect 5, further comprising: transmitting an indication that the LP-SS signaling is associated with the cell identifier of the cell.

Aspect 7: The method of any of aspects 1 through 6, wherein generating the FMCW waveform comprises: generating at least a portion of the FMCW waveform to include a slope that is associated with an identifier of a cell that is associated with the network entity.

Aspect 8: The method of any of aspects 1 through 7, wherein generating the OOK waveform comprises: generating the OOK waveform in accordance with a slope modulation-based waveform shape, wherein the LP-SS signaling comprises slope modulation based signaling.

Aspect 9: The method of any of aspects 1 through 8, wherein generating the FMCW waveform comprises: generating the FMCW waveform in accordance with an X FMCW waveform shape, a V FMCW waveform shape, or a single slope FMCW waveform shape.

Aspect 10: A method for wireless communications at a UE, comprising: monitoring for low power synchronization signal (LP-SS) signaling associated with an on-off keying (OOK) waveform that comprises a plurality of on durations and a plurality of off durations; and monitoring, during at least a portion of the plurality of on durations of the OOK waveform, for SSB signaling associated with a frequency modulated continuous wave (FMCW) waveform overlaid in the plurality of on durations of the OOK waveform.

Aspect 11: The method of aspect 10, further comprising: receiving a modulated waveform comprising the FMCW waveform modulated on the plurality of on durations of the OOK waveform with the OOK waveform.

Aspect 12: The method of any of aspects 10 through 11, further comprising: receiving multiple durations of the OOK waveform within a time period associated with a single orthogonal frequency domain multiplexing (OFDM) symbol duration.

Aspect 13: The method of any of aspects 10 through 12, further comprising: receiving the SSB signaling in association with a primary synchronization signaling (PSS) only occasion.

Aspect 14: The method of any of aspects 10 through 13, further comprising: receiving, via the LP-SS signaling, an indication of a timing offset between the LP-SS signaling and the SSB signaling, a frequency offset between the LP-SS signaling and the SSB signaling, or both.

Aspect 15: The method of any of aspects 10 through 14, further comprising: determining a cell identifier of a cell based at least in part on reception of the LP-SS signaling and an association between the LP-SS signaling and the cell identifier.

Aspect 16: The method of aspect 15, further comprising: receiving an indication that the LP-SS signaling is associated with the identifier of the cell.

Aspect 17: The method of any of aspects 10 through 16, further comprising: receiving a modulated waveform comprising the FMCW waveform modulated on the plurality of on durations of the OOK waveform with the OOK waveform, wherein at least a portion of the FMCW waveform includes a slope that is associated with an identifier of a cell that is associated with a network entity that transmitted the SSB signaling.

Aspect 18: The method of any of aspects 10 through 17, wherein the OOK waveform is based at least in part on a slope modulation-based waveform shape, and the LP-SS signaling comprises slope modulation based signaling.

Aspect 19: The method of any of aspects 10 through 18, wherein the FMCW waveform comprises an X FMCW waveform shape, a V FMCW waveform shape, or a single slope FMCW waveform shape.

Aspect 20: A network entity for wireless communications, comprising one or more memories storing processor-executable code, and one or more processors coupled with the one or more memories and individually or collectively operable to execute the code to cause the network entity to perform a method of any of aspects 1 through 9.

Aspect 21: A network entity for wireless communications, comprising at least one means for performing a method of any of aspects 1 through 9.

Aspect 22: A non-transitory computer-readable medium storing code for wireless communications, the code comprising instructions executable by one or more processors to perform a method of any of aspects 1 through 9.

Aspect 23: A UE for wireless communications, comprising one or more memories storing processor-executable code, and one or more processors coupled with the one or more memories and individually or collectively operable to execute the code to cause the UE to perform a method of any of aspects 10 through 19.

Aspect 24: A UE for wireless communications, comprising at least one means for performing a method of any of aspects 10 through 19.

Aspect 25: A non-transitory computer-readable medium storing code for wireless communications, the code comprising instructions executable by one or more processors to perform a method of any of aspects 10 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity, comprising:
one or more memories storing processor-executable code; and
one or more processors coupled with the one or more memories and individually or collectively operable to execute the code to cause the network entity to:
generate an on-off keying (OOK) waveform associated with communication of low power synchronization signal (LP-SS) signaling, the OOK waveform comprising a plurality of on durations and a plurality of off durations;
generate a frequency modulated continuous wave (FMCW) waveform associated with communication of synchronization signal block (SSB) signaling; and
transmit a modulated waveform comprising the FMCW waveform modulated with the OOK waveform on the plurality of on durations of the OOK waveform.

2. The network entity of claim 1, wherein the one or more processors are individually or collectively further operable to execute the code to cause the network entity to:
transmit multiple durations of the OOK waveform within a time period associated with a single orthogonal frequency domain multiplexing (OFDM) symbol duration.

3. The network entity of claim 1, wherein the one or more processors are individually or collectively further operable to execute the code to cause the network entity to:
transmit the modulated waveform in accordance with a primary synchronization signaling (PSS) only occasion.

4. The network entity of claim 1, wherein the one or more processors are individually or collectively further operable to execute the code to cause the network entity to:
transmit, via the LP-SS signaling, an indication of a timing offset between the LP-SS signaling and the SSB signaling, a frequency offset between the LP-SS signaling and the SSB signaling, or both.

5. The network entity of claim 1, wherein the one or more processors are individually or collectively further operable to execute the code to cause the network entity to:
transmit the LP-SS signaling based at least in part on an association between the LP-SS signaling and a cell identifier of a cell that is associated with the network entity.

6. The network entity of claim 5, wherein the one or more processors are individually or collectively further operable to execute the code to cause the network entity to:
transmit an indication that the LP-SS signaling is associated with the cell identifier of the cell.

7. The network entity of claim 1, wherein, to generate the FMCW waveform, the one or more processors are individually or collectively operable to execute the code to cause the network entity to:
generate at least a portion of the FMCW waveform to include a slope that is associated with an identifier of a cell that is associated with the network entity.

8. The network entity of claim 1, wherein, to generate the OOK waveform, the one or more processors are individually or collectively operable to execute the code to cause the network entity to:
generate the OOK waveform in accordance with a slope modulation-based waveform shape, wherein the LP-SS signaling comprises slope modulation based signaling.

9. The network entity of claim 1, wherein, to generate the FMCW waveform, the one or more processors are individually or collectively operable to execute the code to cause the network entity to:
generate the FMCW waveform in accordance with an X FMCW waveform shape, a V FMCW waveform shape, or a single slope FMCW waveform shape.

10. A user equipment (UE), comprising:
one or more memories storing processor-executable code; and
one or more processors coupled with the one or more memories and individually or collectively operable to execute the code to cause the UE to:
monitor for low power synchronization signal (LP-SS) signaling associated with an on-off keying (OOK) waveform that comprises a plurality of on durations and a plurality of off durations; and
monitor, during at least a portion of the plurality of on durations of the OOK waveform, for SSB signaling associated with a frequency modulated continuous wave (FMCW) waveform overlaid in the plurality of on durations of the OOK waveform.

11. The UE of claim 10, wherein the one or more processors are individually or collectively further operable to execute the code to cause the UE to:
receive a modulated waveform comprising the FMCW waveform modulated on the plurality of on durations of the OOK waveform with the OOK waveform.

12. The UE of claim 10, wherein the one or more processors are individually or collectively further operable to execute the code to cause the UE to:
receive multiple durations of the OOK waveform within a time period associated with a single orthogonal frequency domain multiplexing (OFDM) symbol duration.

13. The UE of claim 10, wherein the one or more processors are individually or collectively further operable to execute the code to cause the UE to:
receive the SSB signaling in association with a primary synchronization signaling (PSS) only occasion.

14. The UE of claim 10, wherein the one or more processors are individually or collectively further operable to execute the code to cause the UE to:
receive, via the LP-SS signaling, an indication of a timing offset between the LP-SS signaling and the SSB signaling, a frequency offset between the LP-SS signaling and the SSB signaling, or both.

15. The UE of claim 10, wherein the one or more processors are individually or collectively further operable to execute the code to cause the UE to:
determine a cell identifier of a cell based at least in part on reception of the LP-SS signaling and an association between the LP-SS signaling and the cell identifier.

16. The UE of claim 15, wherein the one or more processors are individually or collectively further operable to execute the code to cause the UE to:
receive an indication that the LP-SS signaling is associated with the identifier of the cell.

17. The UE of claim 10, wherein the one or more processors are individually or collectively further operable to execute the code to cause the UE to:
receive a modulated waveform comprising the FMCW waveform modulated on the plurality of on durations of the OOK waveform with the OOK waveform, wherein at least a portion of the FMCW waveform includes a slope that is associated with an identifier of a cell that is associated with a network entity that transmitted the SSB signaling.

18. The UE of claim 10, wherein the OOK waveform is based at least in part on a slope modulation-based waveform shape, and the LP-SS signaling comprises slope modulation based signaling.

19. The UE of claim 10, wherein the FMCW waveform comprises an X FMCW waveform shape, a V FMCW waveform shape, or a single slope FMCW waveform shape.

20. A method for wireless communications at a network entity, comprising:
generating an on-off keying (OOK) waveform associated with communication of low power synchronization signal (LP-SS) signaling, the OOK waveform comprising a plurality of on durations and a plurality of off durations;
generating a frequency modulated continuous wave (FMCW) waveform associated with communication of synchronization signal block (SSB) signaling; and
transmitting a modulated waveform comprising the FMCW waveform modulated with the OOK waveform on the plurality of on durations of the OOK waveform.

21. The method of claim 20, further comprising:
transmitting multiple durations of the OOK waveform within a time period associated with a single orthogonal frequency domain multiplexing (OFDM) symbol duration.

22. The method of claim 20, further comprising:
transmitting the modulated waveform in accordance with a primary synchronization signaling (PSS)-only occasion.

23. The method of claim 20, further comprising:
transmitting, via the LP-SS signaling, an indication of a timing offset between the LP-SS signaling and the SSB signaling, a frequency offset between the LP-SS signaling and the SSB signaling, or both.

24. The method of claim 20, further comprising:
transmitting the LP-SS signaling based at least in part on an association between the LP-SS signaling and a cell identifier of a cell that is associated with the network entity.

25. The method of claim 24, further comprising:
transmitting an indication that the LP-SS signaling is associated with the cell identifier of the cell.

26. The method of claim 20, wherein generating the FMCW waveform comprises:
generating at least a portion of the FMCW waveform to include a slope that is associated with an identifier of a cell that is associated with the network entity.

27. The method of claim 20, wherein generating the OOK waveform comprises:
generating the OOK waveform in accordance with a slope modulation-based waveform shape, wherein the LP-SS signaling comprises slope modulation based signaling.

28. The method of claim 20, wherein generating the FMCW waveform comprises:
generating the FMCW waveform in accordance with an X FMCW waveform shape, a V FMCW waveform shape, or a single slope FMCW waveform shape.

29. A method for wireless communications at a user equipment (UE), comprising:
monitoring for low power synchronization signal (LP-SS) signaling associated with an on-off keying (OOK) waveform that comprises a plurality of on durations and a plurality of off durations; and
monitoring, during at least a portion of the plurality of on durations of the OOK waveform, for SSB signaling associated with a frequency modulated continuous wave (FMCW) waveform overlaid in the plurality of on durations of the OOK waveform.

30. The method of claim 29, further comprising:
receiving a modulated waveform comprising the FMCW waveform modulated on the plurality of on durations of the OOK waveform with the OOK waveform.
